(19) United States
(12) Patent Application Publication
(10) Pub. No.: US 2004/0198601 A1
(43) Pub. Date: Oct. 7, 2004

(54) Support for recording material and thermal recording material using the same

(75) Inventor: Shinji Fujimoto, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/811,392

(22) Filed: Mar. 29, 2004

(30) Foreign Application Priority Data
Mar. 28, 2003 (JP) 2003-90063

(51) Int. Cl. B41M 5/20

(52) U.S. Cl. 503/201

(57) ABSTRACT

The present invention provides a support for recording material comprising a fluorescent whitening agent-containing layer containing a fluorescent whitening agent, the support further comprising a blocking layer on at least either one of a space between the fluorescent whitening agent-containing layer and the base support and the side of the fluorescent whitening agent-containing layer on which side the base support is not disposed. The invention also provides a thermal recording material using the support.

### CROSS-REFERENCE TO RELATED APPLICATION

This application claims priority under 35 U S C 119 from Japanese Patent Application No. 2003-90063, the disclosure of which is incorporated by reference herein.

### BACKGROUND OF THE INVENTION

1. Field of the Invention

The present invention relates to a support for recording material, and, particularly, to a support for recording material including a full-color thermal recording material, inkjet receiving sheet, receiving sheet of electrostatic recording and the like.

2. Description of the Related Art

Thermal recording materials in which an image is to be recorded by applying heat using a thermal head and the like are highly reliable, and recording devices for these thermal recording materials are easy to use. Also, the thermal recording materials have many advantages such as requiring no maintenance, and therefore have progressed conspicuously in recent years. The thermal recording materials are provided with a recording layer containing, as color forming components, for example, an electron donating dye precursor and an electron accepting compound, or a diazonium salt compound and a coupler on a support. In the thermal recording material, an image is recorded by making use of a color forming reaction of the color forming components which reaction is advanced by applying heat.

In recent years, many improvements have been made in supports (supports for recording material) used for recording materials for the purpose of improving the whiteness degree of background portion and light fastness of recording materials such as thermal recording materials. As examples of such a support, a photographic support obtained by compounding a fluorescent whitening agent in a polyethylene laminate layer of a support for recording material is disclosed in Japanese Patent Application Laid-Open (JP-A) No. 2-71256. However, when such a photographic support is used for a thermal recording material, problems such as heat decomposition and yellowing occur. Also, the light fastness of the fluorescent whitening agent is unsatisfactory, which causes a problem in that fluorescence is lost due to long-term exposure to light. Therefore, there has been a desire to develop a support for recording material which has excellent light fastness and which enables exhibition of high whiteness degree of background portion and light fastness of background portion when used as a support for a thermal recording material.

### SUMMARY OF THE INVENTION

In order to solve the above problem, a first object of the present invention is to provide a support for recording material which has excellent light fastness and which enables improvement in possible to improve the whiteness degree of background portion and light fastness of background portion of a recording material when used as a support for the thermal recording material.

A second object of the invention is to provide a thermal recording material which has excellent fixing ability, high whiteness degree of background portion, and superior light fastness of background portion.

The above problem can be solved by the following means.

A first aspect of the invention is to provide a support for recording material comprising a base support, and a fluorescent whitening agent-containing layer which is disposed on the base support and contains a fluorescent whitening agent;

the support further comprising a blocking layer on at least either one of a space between the fluorescent whitening agent-containing layer and a base support and a side of the fluorescent whitening agent-containing layer on which side the base support is not disposed.

A second aspect of the present invention is to provide a thermal recording material provided with a support comprising a base support, a fluorescent whitening agent-containing layer which is disposed on the base support and contains a fluorescent whitening agent and, a blocking layer disposed on at least either one of a space between the fluorescent whitening agent-containing layer and the base support and a side of the fluorescent whitening agent-containing layer on which side the base support is not disposed; and at least one thermal recording layer disposed on the support.

### BRIEF DESCRIPTION OF THE DRAWINGS

FIG. 1A is a schematic sectional view showing one layer structure of a support for recording material of the present invention.

FIG. 1B is a schematic sectional view showing another layer structure of a support for recording material of the present invention.

FIG. 1C is a schematic sectional view showing a further layer structure of a support for recording material of the present invention.

### DETAILED DESCRIPTION OF THE INVENTION

<<Support For Recording Material>>

A support for recording material of the present invention (hereinafter referred to simply as “support of the invention”, if necessary) comprises a base support and a fluorescent whitening agent-containing layer which is disposed on the base support and contains a fluorescent whitening agent on the base support; the support further comprising a blocking layer on at least either one of a space between the fluorescent whitening agent-containing layer and the base support and the side of the fluorescent whitening agent-containing layer on which side the base support is not disposed. Since The support of the invention comprises a blocking layer on at least either one of (1) a space between the fluorescent whitening agent-containing layer and the base support and (2) the side of the fluorescent whitening agent-containing layer on which side the base support is not disposed, the light fastness of the support of the invention can be improved. Further, if the support of the invention is used as a support for thermal recording material, the whiteness degree of background portion and light fastness of background portion of the thermal recording material can be improved. This is estimated to be because the providing of the blocking layer as aforementioned improves oxygen-blocking property (gas permeation restricting effect) and makes it difficult for the fluorescent whitening agent contained in the fluorescent whitening agent-containing layer to be in contact with gas, whereby the light fastness of the fluorescent whitening agent is improved. That is, the blocking layer has a function as an oxygen-blocking layer.

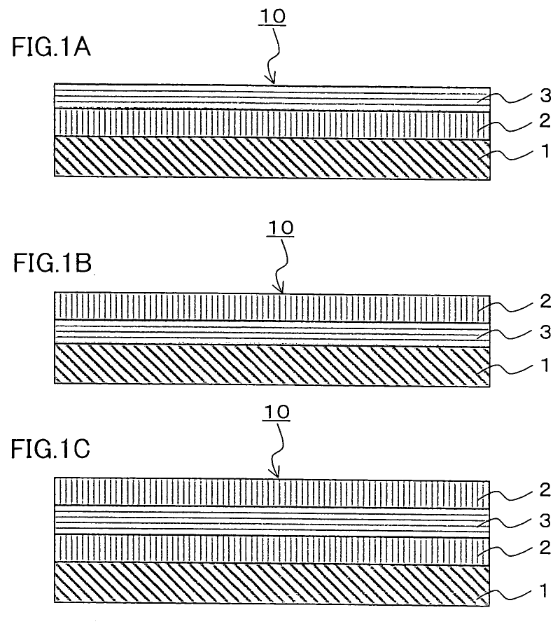

The support of the invention is provided with at least one fluorescent whitening agent-containing layer and at least one blocking layer on the base support. The layer structure of the support of the invention will be explained with reference to FIGS. 1A to 1C. FIGS. 1A to 1C are respectively a schematic sectional view showing the layer structure of the support for recording material of the invention. In FIGS. 1A to 1C, a support for recording material 10 of the invention is constituted of a base support 1, a blocking layer 2 and a fluorescent whitening agent-containing layer 3. FIG. 1A shows an embodiment in which the blocking layer 2 is disposed between the fluorescent whitening agent-containing layer 3 and the base support 1. FIG. 1B shows an embodiment in which the blocking layer 2 is disposed on the fluorescent whitening agent-containing layer 3 on the side on which the base support 1 is not disposed. FIG. 1C shows an embodiment in which the blocking layer 2 is disposed on both the space between the fluorescent whitening agent-containing layer 3 and the base support 1 and the side of the fluorescent whitening agent-containing layer 3 on the side on which side the base support 1 is not disposed.

As the support of the invention, an embodiment in which a fluorescent whitening agent-containing layer is sandwiched between two blocking layers as shown in FIG. 1C is preferable from the viewpoint of developing oxygen-blocking property sufficiently and more improving light fastness.

The support of the invention will be hereinafter explained in detail. ps <Fluorescent Whitening Agent-containing Layer>

The fluorescent whitening agent-containing layer in the invention contains at least a fluorescent whitening agent. As a binder used in the fluorescent whitening agent-containing layer, a gelatin, synthetic high-molecular latex, nitrocellulose or polyvinyl alcohol may be preferably used. Among these compounds, a gelatin or a polymer such as a polyvinyl alcohol, polyvinylpyrrolidone or modified cellulose is preferable as the binder.

The thickness of the fluorescent whitening agent-containing layer in the invention is preferably 0.1 to 5 μm and more preferably 0.2 to 3 μm. If the thickness of the fluorescent whitening agent-containing layer is in a range from 0.1 μm to 5 μm, sufficient fluorescence intensity can be obtained and coating and drying loads are decreased when a coating layer is formed, leading to high productivity.

(Fluorescent Whitening Agent)

For example, the compounds described in “The Chemistry of Synthetic Dyes” edited by K. Veen-Rataramann, Vol. V, Chapter 8 may be used as the fluorescent whitening agent contained in the fluorescent whitening agent-containing layer in the invention. Specific examples of the fluorescent whitening agent include stilbene type compounds, cumarin type compounds, biphenyl type compounds, benzoxazolyl type compounds, naphthalimide type compounds, pyrazoline type compounds and carbostyryl type compounds.

The following explanations will be hereinafter described as to the fluorescent whitening agent by classifying it into a water-soluble fluorescent whitening agent and an oil-soluble fluorescent whitening agent by solubility.

As the water-soluble fluorescent whitening agent, stilbene type whitening agents having a water-soluble group which agents are listed in U.S. Pat. No. 2,933,390, Japanese Patent Application Publication (JP-B) No.48-30495 and JP-A No. 55-135833 are used primarily. Among these stilbene type whitening agents, particularly water-soluble diaminostilbene compounds are preferably used. These water-soluble aminostilbene compounds more preferably have a sulfone group as the water-soluble group.

Particularly, fluorescent whitening agents including 4,4′-diaminostilbenedisulfonic acid derivatives may be synthesized using usual methods described in, for example, “Fluorescent whitening agents” edited by Chemical Product Industry Association (issued on August, 1976).

The water- soluble fluorescent whitening agent used in the invention may be added as an aqueous solution as it is.

As the oil-soluble fluorescent whitening agent, substituted stilbene, substituted cumarin described in U.K. Patent No. 786,234 and substituted thiophenes described in U.S. Pat. No. 3,135,762 are preferable. Additionally, fluorescent whitening agents as described in JP-B No. 45-37376 and JP-A No. 50-126732 may be used.

When the aforementioned oil-soluble fluorescent whitening agent is used, a method of adding it as an emulsion or a method of adding it as a latex dispersion is primarily used.

As regards the method of producing the emulsion, for example, the aforementioned oil-soluble fluorescent whitening agent is dissolved in a high-boiling point organic solvent or water-insoluble polymer to emulsify whereby the emulsion can be prepared. Specifically, an oil-soluble fluorescent whitening agent is dissolved in a high-boiling point organic solvent as exemplified in U.K. Patent No. 1072915 and the resulting solution is emulsified together with a surfactant in a hydrophilic colloid such as a gelatin. As the high-boiling point solvent, besides phthalates and phosphates, amide compounds, benzoates, substituted paraffins and the like may be used. Also, the emulsion may be prepared in the same manner as above by using a water-insoluble polymer such as a polyurethane and polyacrylate in place of the high-boiling point organic solvent.

Examples of the method for preparing the aforementioned latex dispersion include a method in which the oil-soluble fluorescent whitening agent is polymerized, after it is dissolved in a monomer in advance, to produce a latex dispersion and a method in which a hydrophobic polymer is made to be impregnated with the oil-soluble fluorescent whitening agent by using an auxiliary solvent to prepare a latex dispersion. These methods are disclosed in, for example, JP-A No. 50-126732, JP-B No. 51-47043, and U.S. Pat. Nos. 3,418,127, 3,359,102, 3,558,316 and 3,788,854.

As the fluorescent whitening agent to be contained in the fluorescent whitening agent-containing layer in the invention, a water-soluble fluorescent whitening agent is preferable from the viewpoint that it is highly soluble in a hydrophilic binder and sufficient fluorescence intensity is easily obtained.

The content of the fluorescent whitening agent in the fluorescent whitening agent-containing layer is preferably 0.5 to 40% by mass and more preferably 5 to 20% by mass based on the hydrophilic polymer when a water-soluble fluorescent whitening agent is used. Also, the content of the fluorescent whitening agent in the fluorescent whitening agent-containing layer is preferably 0.5 to 20% by mass and more preferably 1 to 10% by mass based on the high-boiling point organic solvent used to dissolve the agent or on the water-insoluble polymer when an oil-soluble fluorescent whitening agent is used.

When the content of the water-soluble and oil-soluble fluorescent whitening agent is in the above range, a reduction in fluorescence intensity, that is, so-called concentration quenching scarcely occurs and it is therefore possible to obtain necessary and sufficient fluorescence intensity.

(Dying Agent for Fluorescent Whitening Agent)

In the invention, a dying agent for fluorescent whitening agent may be contained together with the fluorescent whitening agent in the fluorescent whitening agent-containing layer from the viewpoint of preventing the fluorescent whitening agent from diffusing to other layers and improving water resistance. As the dying agent for fluorescent whitening agent, N-vinylpyrrolidone type polymers described in JP-B Nos. 43-13498 and 43-22882, U.S. Pat. Nos. 3,052,544, 3,666,470, 3,167,429, 3,168,403 and 3,252,801, pyridine type polymers described in U.S. Pat. Nos. 2,448,507, 2,448,508and 2,721,852, morpholine type polymers described in U.S. Pat. No. 3,341,332 and oxazolidine type polymers and polyvinyl alcohol type polymers described in U.S. Pat. No. 3,006,762 may be used. Among these compounds, water-soluble or water-dispersible resins such as vinylpyrrolidone and vinyl alcohol are most preferable.

In the invention, the content of the dying agent for fluorescent whitening agent in the fluorescent whitening agent-containing layer is preferably 5 to 100% by mass and particularly preferably 25 to 100% by mass based on the total polymer component. When the content of the dying agent for fluorescent whitening agent is in the above range, the dying ability of the fluorescent whitening agent is sufficiently achieved, so that a reduction in whiteness and yellow density scarcely occurs.

(Others)

Additionally, an antifoaming agent may be added to the fluorescent whitening agent-containing layer to prevent foaming during coating. Also, a surfactant may be added to better the leveling of a solution thereby preventing the occurrence of coating stripes. Moreover, an antistatic agent may be added, if necessary. Also, the fluorescent whitening agent-containing layer may be made to be opaque by adding a white pigment thereto.

<Blocking Layer>

In the invention, the blocking layer preferably contains at least a water-soluble polymer. It is preferable that the blocking layer further contain a layered inorganic compound. Also, the aforementioned blocking layer may contain other additives such as a surfactant, if necessary.

The thickness of the blocking layer is preferably 0.1 to 5 μm and more preferably 0.5 to 3 μm. When the thickness of the blocking layer is in a range from 0.1 to 5 μm, sufficient gas-blocking property can be developed and light fastness can be heightened. Also, when the thickness of the blocking layer is in the above range, a load for application and drying when forming a coating layer is decreased and high productivity is obtained.

(Water-soluble Polymer)

In the invention, the blocking layer preferably contains a high-molecular binder having low gas permeability. Examples of the high-molecular binder may include a polyvinylidene chloride, polyester resin, polyimide resin and polyamide resin. Among these polymers, a water-soluble polymer is preferably contained in the aforementioned blocking layer. Examples of the water-soluble polymer include polyvinyl alcohols (including modified PVAs such as acetoacetyl-modified PVA, carboxyl-modified PVA and silanol-modified PVA), gelatin, modified cellulose, polyvinylpyrrolidone, maleic acid anhydride copolymer and modified polyamide. Among these compounds, any one of polyvinyl alcohols and gelatin is preferable and polyvinyl alcohols are particularly preferable as the water-soluble polymer used in the blocking layer. When a polyvinyl alcohol or gelatin is used as the water-soluble polymer, light fastness can be more improved.

Examples of the polyvinyl alcohols include, besides polyvinyl alcohols, modified polyvinyl alcohols such as silanol-modified polyvinyl alcohols, carboxy-modified polyvinyl alcohol, amino-modified polyvinyl alcohols, itaconic acid-modified polyvinyl alcohols, long-chain alkyl ether-modified polyvinyl alcohols and acetoacetyl -modified polyvinyl alcohols. Among these compounds, acetoacetyl-modified polyvinyl alcohols are particularly preferable.

The content of the water-soluble polymer in the blocking layer is preferably 5% to 100% and more preferably 10 to 95%. If the content of the water-soluble polymer is in a range from 5 to 100%, a stable and tough coating layer can be formed.

(Layered Inorganic Compound)

In the invention, it is preferable that the blocking layer further contain a layered inorganic compound. When the blocking layer is made to contain a layered inorganic compound, the light fastness of the support of the invention can be more improved.

As the layered inorganic compound, a swelling layered inorganic compound is preferable. Examples of the layered inorganic compound include swelling clay minerals such as bentonite, hectorite, saponite, bieberite, nontronite, stibuncite, beidellite and montmorillonite, swelling synthetic mica and swelling synthetic smectites. These swelling layered inorganic compounds respectively have a laminate structure composed of a unit crystal lattice layer 1 to 1.5 nm in thickness and have outstandingly larger inter-lattice metal atom substitution than other clay minerals. As a result, the lattice layer lacks positive charges and therefore adsorbs cations such as Na⁺, Ca²⁺ or Mg²⁺ to compensate the lacks. These cations interposed between layers are called exchangeable cations and exchanged with various cations. Particularly, in the case where the interlayer cation is Li⁺, Na⁺ or the like, bonding strength between layered crystal lattices is low and these layered inorganic compounds are largely swelled by water because these metals respectively have a small ionic radius. When applying shear in this condition, these metals are easily cleft and forms a stable sol in water. Bentonite and swelling synthetic mica exhibit this tendency strongly and are therefore desirable to achieve the object of the invention. Particularly, water-swelling synthetic mica is preferable as the layered inorganic compound used in the invention.

Examples of the water-swelling synthetic mica include Na tetrasic mica:NaMg_{2.5}(Si₄O₁₀)F₂, Na teniorite:

(Na)Mg₂(Si₄O₁₀)F₂, Li teniorite: (Li)Mg₂(Si₄O₁₀)F₂, Na hectorite:

(Na)_{1/3}Mg_{8/3} Li_{1/3} (Si₄O₁₀)F₂ and Li hectorite: (Li)_{1/3}Mg _{8/3}Li_{1/3} (Si₄O₁₀) F₂.

The size of the water-swelling synthetic mica which is preferably used in the invention is as follows: thickness: 1 to 50 nm and plane size: 1 to 20 μm. It is better that the thickness is lower to control diffusion. Also, it is better that the plane size is larger to the extent that the smoothness and transparency of the coating surface are not impaired. Therefore, the aspect ratio is 100 or more, preferably 200 or more and particularly preferably 500 or more.

The amount of the water-swelling synthetic mica to be applied is preferably 0.02 g/m² to 1 g/m² and more preferably 0.05 g/m² to 0.6 g/m² from the viewpoint of suppressing the permeation of oxygen.

(Others)

It is possible to add, other than the above, an antifoaming agent to break bubbles formed during coating and an activator to better the leveling of a solution thereby preventing the occurrence of coating stripes. Also, an antistatic agent may be added, if necessary. Moreover, the blocking layer may be made to be opaque by adding a white pigment thereto.

<Base Support>

As the base support in the invention, though no particular limitation is imposed on it, paper supports, synthetic resin supports including polyolefin films such as a polyethylene and polypropylene, polyester films such as a polyethylene terephthalate, cellulose derivative films such as triacetyl cellulose and polyethylene films, plate glass, metal plates may be used. A paper support is particularly preferable in light of handling characteristics and feeling. As the paper support, those obtained by using natural pulp selected from coniferous trees, broad-leaved trees and the like as a major raw material and by adding, as required, fillers such as clay, talc, calcium carbonate and urea resin particles, sizing agents such as rosin, alkylketene dimers, higher fatty acids, epoxidized fatty acid amides, paraffin waxes and alkenylsuccinic acid, paper strengthening agents such as starch, polyamidopolyamineepichlorohydrins and polyacrylamides and fixing agents such as alum cake and cationic polymers. Also, a softening agent such as surfactants may be added in addition to the aforementioned components. Moreover, as the paper support, synthetic paper using synthetic pulp may be used in place of natural pulp. A raw material obtained by mixing natural pulp with synthetic pulp in a desired ratio may be used. As the paper support, it is preferable to use broad-leaved tree pulp which is short fibers improving smoothness. The hydrature of the pulp material to be used is preferably 200 to 500 ml (C.S.F) and more preferably 300 to 400 ml.

A sizing agent, a softening agent, a paper strengthening agent, a fixing agent and the like may be added as other ingredients to the paper support.

Examples of the sizing agent include rosin, paraffin waxes, higher fatty acid salts, alkenyl succinates, fatty acid anhydrides, styrene/maleic acid anhydride copolymers, alkylketene dimers and epoxidized fatty acid amides.

Examples of the softening agent include reaction products between maleic acid anhydride copolymers and polyalkylenepolyamine and quaternary ammonium salts of higher fatty acids.

Examples of the paper strengthening agents include polyacrylamides, starch, polyvinyl alcohols, melamine formaldehyde condensates and gelatins.

Examples of the fixing agent include alum cake and polyamidopolyamineepichlorohydrin. Additionally, dyes, fluorescent dyes, antistatic agents and the like may be added, if necessary.

The support of the invention preferably uses, as the base support, one obtained by disposing a water-resistant resin coating layer on both surfaces of base paper (paper support) is preferably used from the viewpoint of plainness, providing of glossy feel and water resistance. The water-resistant resin coating layer is a layer composed of a water-resistant resin and disposed on the base paper (paper support). As the water-resistant resin, a polyolefin is preferable. When a base support obtained by laminating a polyolefin on both surfaces of the base paper (paper support) is used, the surface smoothness of the support of the invention is improved and a so-called blister which is a difference in altitude between the thicknesses of an image portion and occurs by image density can be decreased. As the polyolefin, a polyethylene may be preferably used.

The water-resistant resin coating layer may be formed on both surfaces of base paper (paper support) by laminating treatment. The laminating treatment may be carried out using a method selected properly from known methods as described in “New Laminate Process Handbook” edited by A society for the Study of Process Technology. As the laminating treatment, methods such as a co-called dry lamination, non-solvent type dry lamination and hot melt lamination may be adopted. In the case of forming the water-resistant resin coating layer by, for example, dry lamination, for example, an adhesive is applied to one surface of a polyolefin resin film and dried as desired and the resin film is applied to the surface of the base paper by thermocompression bonding, whereby the water-resistant resin coating layer can be formed. Examples of the adhesive include a solvent type vinyl resin, acryl type resin, polyamide type resin, epoxy type resin, rubber type resin and urethane resin. The surface or backface or both surfaces of the base paper may be processed by corona discharge treatment to thereby improve the adhesion to the water-resistant resin coating layer.

Also, it is preferable to activate the surface of the base support by a known method before a coating solution is applied to the base support to form the blocking layer or the fluorescent whitening agent-containing layer. As the activating treatment, etching treatment using an acid, flame treatment using a gas burner, corona discharge treatment, glow discharge treatment or the like may be used. The surface activation is preferably carried out using corona discharge treatment described in U.S. Pat. Nos. 2,715,075, 2,846,727, 3,549,406 and 3,590,107 and the like from the viewpoint of low cost and convenience.

In the invention, coating solutions for the blocking layer, fluorescent whitening agent-containing layer and the like may be applied onto the base support by using generally known coating methods such as a dip coating method, air knife coating method, curtain coating method, roller coating method, doctor coating method, wire bar coating method, slide coating method and gravure coating method, extrusion coating method using a hopper and described in U.S. Pat. No. 2,681,294 or the like. Also, if necessary, these layers are divided into two or more layers, which are then coated simultaneously by using the methods described in, for example, the specification of U.S. Pat. Nos. 2,761,791, 3,508,947, 2,941,898 and 3,526,528 and HARASAKI Yuji “Coating Engineering” page 253 (published by Asakura Shoten (1973)). An appropriate method may be selected according to the amount to be applied, coating speed and the like.

A pigment dispersant, a thickener, a fluidity modifier, an antifoaming agent, a foam suppressor, a releasing agent and a colorant may be properly compounded in the coating solutions used in the invention, if necessary without any problem as far as these additives do not impair the characteristics of these layers concerned.

<<Thermal Recording Material>>

The support of the invention may be preferably used as a support for thermal recording material provided with a thermal recording layer which can develop a color by supplying heat.

The thermal recording material of the invention is provided with at least one thermal recording layer on the aforementioned support of the invention. The thermal recording material of the invention uses the support of the invention which is provided with the fluorescent whitening agent-containing layer and the blocking layer as the support, whereby the whiteness degree of background portion and light fastness can be improved.

<Thermal Recording Layer>

When the thermal recording material of the invention is made into a recording material for forming a multicolor image, two or more thermal recording layers which can develop different colors respectively by supplying heat. Particularly, in the case of a multicolor recording material, the energies supplied to each recording layer are made to be different in level to thereby develop desired colors. Therefore, the occurrence of blister becomes significant during printing with high printing energy. However, when the support of the invention is used, the occurrence of blister can be suppressed effectively due to the gas (steam) permeation restricting effect of the support of the invention and it is therefore possible to maintain the high quality of a multicolor image.

In the case where the thermal recording material of the invention is made into a multicolor recording material, thermal recording layers developing cyan, magenta and yellow colors respectively are formed, whereby a thermal recording material capable of forming a full-color image can be obtained. As regards a multicolor thermal recording material, the structural examples and recording methods described in JP-A No. 11-34495, Column 36 to Column 38 can be applied to the invention.

It is preferable that the thermal recording layer contain a color forming component which is colorless in a normal temperature and pressure condition and enters into a color forming reaction by supplying heat and applying pressure. Examples of the color forming component include combinations of the following (a) to (r).

(a) A combination of an electron donating dye precursor and an electron accepting compound.

(b) A combination of a diazo compound and a coupling component (hereinafter called “coupler compound”, if necessary).

(c) A combination of an organic acid metal salt such as silver behenate and silver stearate and a reducing agent such as protocatechnic acid, spiroindane and hydroquinone.

(d) A combination of a long-chain fatty acid iron salt such as ferric stearate and ferric myristate and phenols such as tannic acid, gallic acid and ammonium salicylate.

(e) A combination of an organic acid-heavy metal salt such as nickel, cobalt, lead, copper, iron, mercury or silver salts of acetic acid, stearic acid, palmitic acid or the like and an alkali metal or alkali earth metal sulfide such as calcium sulfide, strontium sulfide or potassium sulfide; or a combination of the aforementioned organic acid-heavy metal salt and an organic chelating agent such as s-diphenylcarbazide or diphenylcarbazone.

(f) A combination of a heavy metal sulfate such as a sulfate of silver, lead, mercury or sodium and a sulfur compound such as sodium tetrathionate, sodium thiosulfate and thio urea.

(g) A combination of an aliphatic ferric salt such as ferric stearate and an aromatic polyhydroxy compound such as 3,4-hydroxytetraphenylmethane.

(h) A combination of an organic acid metal salt such as silver oxalate or mercury oxalate and an organic polyhydroxy compound such as a polyhydroxy alcohol, glycerol or glycol.

(i) A combination of a fatty acid ferric salt such as ferric pelargonate or ferric laurate and a thiocecylcarbamide or isothiocecylcarbamide derivative.

(j) A combination of an organic acid lead salt such as lead caproate, lead pelargonate or lead behenate and a thiourea derivative such as ethylenethiourea or N-dodecylthiourea.

(k) A combination of a higher aliphatic heavy metal salt such as ferric stearate or copper stearate and a zinc dialkyldithiocarbamate.

(l) A combination forming an oxazine dye such as a combination of resorcin and a nitroso compound.

(m) A combination of a formazan compound and at least one of a reducing agent and a metal salt.

(n) A combination of a protected dye (or leuco dye) precursor and a deprotective agent.

(o) A combination of an oxidation type color forming agent and an oxidant.

(p) A combination of phthalonitriles and diiminoisoindolines (a combination producing a phthalocyanine).

(q) A combination of isocyanates and diiminoisoindolines (a combination producing a color pigment).

(r) A combination of a pigment precursor and an acid or base (a combination producing a pigment).

As the color forming component, (a) a combination of an electron donating dye precursor and an electron accepting compound and (b) a combination of a diazo compound and a coupling component are particularly preferable. As the aforementioned electron donating dye precursor, electron accepting compound, diazo compound and coupling component, appropriate materials selected from those described in JP-A No. 11-34495 may be used.

[Others]

The support for recording material of the invention may be used for, besides the aforementioned materials, recording materials such as silver halide photographs, ink jet receiving sheets and electrostatic recording receiving sheet.

### EXAMPLES

The present invention will be hereinafter explained in detail by way of examples, which, however, are not intended to be limiting of the invention, in which all designations of “part” and “%” indicate “part by mass” and “% by mass”, respectively, unless otherwise noted.

### Example 1

<Production of a Support For Thermal Recording Material>

Information was printed on the side opposite to a recording layer on the surface of a paper support having a basic weight of 170 g/m², followed by drying. Thereafter, a mixed resin of a high-density polyethylene (HDPE) and a low-density polyethylene (LDPE) was laminated on the printed surface by melt extrusion and the laminate surface was embossed using a cooling emboss roll. Next, a LDPE mixture containing titanium dioxide in an amount of 12% based on the polyethylene was laminated on a surface for coating the recording layer in a thickness of 30 μm. After the LDPE mixture was laminated, the laminate surface was embossed using a cooling emboss roll to manufacture a base support. Next, the polyethylene surface layer of the base support was subjected to glow discharge treatment. Then, the following coating solution A for fluorescent whitening agent-containing layer and the following coating solution B for blocking layer were applied one by one using a gravure coater, followed by drying to form a blocking layer 3.4 μm in thickness on the fluorescent whitening agent-containing layer 0.28 μm in thickness. By this process, a support for recording material (Example 1) was obtained.

<Preparation of Coating Solution a for Fluorescent Whitening Agent-containing Layer>

First, (iii) a polyvinylpyrrolidone (trade name: PVP-K30, manufactured by ISP) was added to (i) water and (ii) methanol and these components were sufficiently mixed with stirring to dissolve the polyvinylpyrrolidone.

Next, (iv) a fluorescent whitening agent (trade name: Tinopal SFP, manufactured by Ciba Specialty Chemicals Inc.) was added to the solution. After that, the temperature of the solution was kept at 30° C. to 35° C. to obtain a coating solution A for fluorescent whitening agent-containing layer.

[Composition of coating solution A for fluorescent whitening
agent-containing layer]

| | |
|---|---|
| (i) Water | 24.33 parts |
| (ii) Methanol | 24.33 parts |
| (iii) Polyvinylpyrrolidone | 1.01 parts |
| (iv) Fluorescent whitening agent | 0.27 parts |

<Preparation of Coating Solution B for Blocking Layer>

First, (ii) water was added to (i) a 15% gelatin solution, which was then heated to 50° C. and sufficiently mixed with stirring.

Next, (iii) a fluorine type surfactant (trade name: Surflon S-131, manufactured by ASAHI GLASS CO., LTD.) was added to the mixture. Then, the temperature of the solution was kept at 40° C. to obtain a coating solution B for blocking layer.

[Composition of coating solution B for blocking layer]

| | |
|---|---|
| (i) Gelatin solution (15% solution) | 53.33 parts |
| (ii) Water | 142.41 parts |
| (iii) Fluorine type surfactant | 0.26 parts |

### Example 2

A support for recording material (Example 2) was obtained in the same manner as in Example 1 except that the coating solution B for blocking layer was changed to a coating solution C for blocking layer, which had the following composition, in Example 1.

<Preparation of Coating Solution C for Blocking Layer>

First, (ii) water was added to (i) a 12.85% acetoacetyl-modified PVA solution (degree of saponification: 95 to 97%, degree of polymerization: 1000, trade name: Gosefimer Z-210, manufactured by The Nippon Synthetic Chemical Industry Co., Ltd.), which was then thoroughly mixed with stirring.

Next, (iii) a fluorine type surfactant (trade name: Surflon S-131, manufactured by ASAHI GLASS CO., LTD.) was added to the mixture. Then, the temperature of the solution was kept at 30° C. to 35° C. to obtain a coating solution C for blocking layer.

[Composition of coating solution C for blocking layer]

| | |
|---|---|
| (i) Acetoacetyl-modified PVA solution (12.85% solution) | 62.11 parts |
| (ii) Water | 133.63 parts |
| (iii) Fluorine type surfactant | 0.26 parts |

### Example 3

A support for recording material (Example 3) was obtained in the same manner as in Example 1 except that the coating solution B for blocking layer B was changed to a coating solution D for blocking layer, which had the following composition, in Example 1 to form a blocking layer 0.86 μm in thickness.

<Preparation of Coating Solution D for Blocking Layer>

First, (ii) water and (iii) methanol were added to (i) a 12.85% acetoacetyl-modified PVA solution (degree of saponification: 95 to 97%, degree of polymerization: 1000, trade name: Gosefimer Z-210, manufactured by The Nippon Synthetic Chemical Industry Co., Ltd.), which was then thoroughly mixed with stirring.

Next, (iv) a water swelling synthetic mica dispersion solution (aspect ratio: 1000, trade name: Somacif MEB-3.8% solution, manufactured by CO-OP CHEMICAL CO., LTD., mica dispersion having an average particle diameter of 2.0 μm) was added to the mixture which was then thoroughly stirred. Thereafter, (v) an ethylene oxide type surfactant (1.66% methanol solution, C₁₂H₂₅O(CH₂CH₂O)₁₀H) and (vi) an aqueous 1N sodium hydroxide solution were further added to the resulting mixture. Then, the temperature of the solution was kept at 30° C. to 35° C. to obtain a coating solution D for blocking layer.

[Composition of coating solution D for blocking layer]

| | |
|---|---|
| (i) Acetoacetyl-modified PVA solution (12.85% solution) | 89.30 parts |
| (ii) Water | 14.68 parts |
| (iii) Methanol | 85.98 parts |
| (iv) Water swelling synthetic mica dispersion solution | 16.88 parts |
| (v) Ethylene oxide type surfactant | 2.77 parts |
| (vi) Aqueous 1 N sodium hydroxide solution | 0.40 parts |

### Example 4

In Example 1, the coating solution B for blocking layer was changed to the coating solution D for blocking layer having the aforementioned composition. The aforementioned coating solution A for fluorescent whitening agent-containing layer and coating solution D for blocking layer were applied to the base support in the order of the coating solution D, the coating solution A and the coating solution D by using a gravure coater, followed by drying to form a 0.86 μm-thick blocking layer, a 0.28 μm-fluorescent whitening agent-containing layer and a 0.86 μm-thick blocking layer in this order. The same procedures as in Example 1 were conducted except for the aforementioned process to obtain a support for recording material (Example 4).

### Example 5

In Example 3, the coating solution A for fluorescent whitening agent-containing layer was changed to a coating solution E for fluorescent whitening agent-containing layer which had the following composition and the coating solution D for blocking layer was changed to a coating solution F for blocking layer which had the following composition to form a 0.4 μm-thick fluorescent whitening agent-containing layer and a 0.86 μm-thick blocking layer. The same procedures as in Example 3 were conducted except for the aforementioned process to obtain a support for recording material (Example 5).

<Preparation of Coating Solution E for Fluorescent Whitening Agent-containing Layer>

First, (ii) water and (iii) methanol were added to (i) a 12.85% acetoacetyl-modified PVA solution (degree of saponification: 95 to 97%, degree of polymerization: 1000, trade name: Gosefimer Z-210, manufactured by The Nippon Synthetic Chemical Industry Co., Ltd.), which was then thoroughly mixed with stirring.

Next, (iv) a fluorescent whitening agent (trade name: Kaycoll BXNL, manufactured by NIPPON SODA CO., LTD.) was added to the mixture. Then, the temperature of the solution was kept at 30° C. to 35° C. to obtain a coating solution E for fluorescent whitening agent-containing layer.

[Composition of coating solution E for fluorescent whitening
agent-containing layer]

| | |
|---|---|
| (i) Acetoacetyl-modified PVA solution (12.85% solution) | 37.71 parts |
| (ii) Water | 141.51 parts |
| (iii) Methanol | 117.71 parts |
| (iv) Fluorescent whitening agent | 3.06 parts |

[Composition of coating solution F for blocking layer]

| | |
|---|---|
| (i) Acetoacetyl-modified PVA solution (12.85% solution) | 214.32 parts |
| (ii) Water | 35.23 parts |
| (iii) Methanol | 203.36 parts |
| (iv) Water swelling synthetic mica dispersion solution | 40.5 parts |
| (v) Ethylene oxide type surfactant | 6.64 parts |
| (vi) Aqueous 1N sodium hydroxide solution | 0.95 parts |

### Example 6

In Example 5, the aforementioned coating solution F for blocking layer and the aforementioned coating solution E for fluorescent whitening agent-containing layer were applied to the base support in the order of the coating solution F and the coating solution E by using a gravure coater, followed by drying to form a 0.86 μm-thick blocking layer and a 0.4 μm-fluorescent whitening agent-containing layer in this order. The same procedures as in Example 5 were conducted except for the aforementioned process to obtain a support for recording material (Example 6).

### Example 7

The same procedures as in Example 5 were conducted except that in Example 5, the aforementioned coating solution F for blocking layer and the aforementioned coating solution E for fluorescent whitening agent-containing layer were applied to the base support in the order of the coating solution F, the coating solution E and the coating solution F by using a gravure coater, followed by drying to form a 0.86 μm-thick blocking layer, a 0.4 μm-fluorescent whitening agent-containing-layer and a 0.86 μm-thick blocking layer in this order, to obtain a support for recording material (Example 7).

### Example 8

In Example 5, the coating solution E for fluorescent whitening agent-containing layer was changed to a coating solution G for fluorescent whitening agent-containing layer which had the following composition, and the aforementioned coating solution F for blocking layer and the aforementioned coating solution G for fluorescent whitening agent-containing layer were applied to the base support in the order of the coating solution F, the coating solution G and the coating solution F by using a gravure coater, followed by drying to form a 0.86-μm-thick blocking layer, a 0.8-μm-fluorescent whitening agent-containing-layer and a 0.86-μm-thick blocking layer in this order on the support. The same procedures as in Example 5 were conducted except for the aforementioned process to obtain a support for recording material (Example 8).

[Composition of coating solution G for fluorescent whitening
agent-containing layer]

| | |
|---|---|
| (i) Acetoacetyl-modified PVA solution (12.85% solution) | 62.85 parts |
| (ii) Water | 235.86 parts |
| (iii) Methanol | 196.19 parts |
| (iv) Fluorescent whitening agent | 5.1 parts |

### Example 9

In Example 5, the coating solution E for fluorescent whitening agent-containing layer was changed to a coating solution H for fluorescent whitening agent-containing layer which had the following composition, and the aforementioned coating solution F for blocking layer and the aforementioned coating solution H for fluorescent whitening agent-containing layer were applied to the base support in the order of the coating solution F, the coating solution H and the coating solution F by using a gravure coater, followed by drying to form a 0.86 μm-thick blocking layer, a 1.6 μm-fluorescent whitening agent-containing-layer and a 0.86 μm-thick blocking layer in this order. The same procedures as in Example 5 were conducted except for the aforementioned process to obtain a support for recording material (Example 9).

[Composition of coating solution H for fluorescent whitening
agent-containing layer]

| | |
|---|---|
| (i) Acetoacetyl-modified PVA solution (12.85% solution) | 125.7 parts |
| (ii) Water | 171.71 parts |
| (iii) Methanol | 192.38 parts |
| (iv) Fluorescent whitening agent | 10.2 parts |

### Comparative Example 1

In Example 1, the blocking layer was not disposed and only a 0.28 μm-thick fluorescent whitening agent-containing layer was formed on the base support by applying the coating solution A for fluorescent whitening agent-containing layer to the base support followed by drying. The same procedures were conducted in the same manner as in Example 1 except for the aforementioned process to obtain a support for recording material (Comparative Example 1).

### Comparative Example 2

In Comparative Example 1, the coating solution A for fluorescent whitening agent-containing layer was changed to the coating solution G for fluorescent whitening agent-containing layer to form a 0.8 μm-thick fluorescent whitening agent-containing layer. The same procedures were conducted in the same manner as in Comparative Example 1 except for the aforementioned process to obtain a support for recording material (Comparative Example 2).

### Comparative Example 3

In Comparative Example 1, the coating solution A for fluorescent whitening agent-containing layer was changed to the coating solution E for fluorescent whitening agent-containing layer to form a 0.4 μm-thick fluorescent whitening agent-containing layer. The same procedures were conducted in the same manner as in Comparative Example 1 except for the aforementioned process to obtain a support for recording material (Comparative Example 3).

<<EVALUATION>>

The retained rate of fluorescence intensity of each support for recording material obtained in the aforementioned manner was measured as the index of light fastness. A support having a higher retained rate of fluorescence intensity is superior in light fastness.

—Measurement of the Retained Rate of Fluorescence Intensity—

First, using a color analyzer C2000S (light source: D65, manufactured by Hitachi, Ltd.), the reflectance (R₁) of the support for recording material at 435 nm and the reflectance (R₀) of the base support at 435 nm before the undercoat layer was formed were measured to define the difference (R₁-R₀) as a fresh fluorescence intensity (X).

Then, the support for recording material was irradiated with light from a xenon weather ometer (trade name: Ci5000 manufactured by Atlas Electric Devices Corp.). The reflectance (R₂) of the support for recording material at 435 nm was measured in the same manner as above. The difference (R₂-R₀) between the reflectance (R₂) and the reflectance (R₀) of the base support before the undercoat layer was formed was defined as a fluorescence intensity (Y) after exposure to light to calculate the retained rate of fluorescence intensity according to the following equation. The results are shown in Table 1.

Retained rate of fluorescence intensity (%)=[(Fluorescence intensity after exposure to light (Y)/Fresh fluorescence intensity (X))×100]

TABLE 1

| | | |
|---|---|---|
| Blocking layer | Fluorescent whitening | Blocking layer (on the side |
| (base support side) | agent-containing layer | opposite to the base support) |

| | | | | | | | | | | | | |
|---|---|---|---|---|---|---|---|---|---|---|---|---|
| | | | Ratio | | Amount of | | | | | | Ratio | +HC,58 |
| | | | of mica | | flourescent | | | | | | of mica | Retained |
| | Thick- | Water- | to be | | whitening | Thick- | Water- | | | Water- | to be | rate of |
| Coating | ness | soluble | added | Coating | agent | ness | soluble | Coating | Thickness | soluble | added | fluorescence |
| solution | (μm) | polymer | (%) | solution | (mg/m²) | (μm) | polymer | solution | (μm) | polymer | (%) | intensity (%) |

| | | | | | | | | | | | | | |
|---|---|---|---|---|---|---|---|---|---|---|---|---|---|
| Example 1 | — | — | — | — | A | 56 | 0.28 | PVP | B | 3.4 | Gelatin | 0 | 50 |
| Example 2 | — | — | — | — | A | 56 | 0.28 | PVP | C | 3.4 | PVA | 0 | 92 |
| Example 3 | — | — | — | — | A | 56 | 0.28 | PVP | D | 0.86 | PVA | 10.5 | 77 |
| Example 4 | D | 0.86 | PVA | 10.5 | A | 56 | 0.28 | PVP | D | 0.86 | PVA | 10.5 | 95 |
| Example 5 | — | — | — | — | E | 60 | 0.4 | PVA | F | 0.86 | PVA | 10.5 | 60 |
| Example 6 | F | 0.86 | PVA | 10.5 | E | 60 | 0.4 | PVA | — | — | — | — | 64 |
| Example 7 | F | 0.86 | PVA | 10.5 | E | 60 | 0.4 | PVA | F | 0.86 | PVA | 10.5 | 84 |
| Example 8 | F | 0.86 | PVA | 10.5 | G | 120 | 0.8 | PVA | F | 0.86 | PVA | 10.5 | 89 |
| Example 9 | F | 0.86 | PVA | 10.5 | H | 240 | 1.6 | PVA | F | 0.86 | PVA | 10.5 | 90 |
| Comparative | — | — | — | — | A | 56 | 0.28 | PVP | — | — | — | — | 17 |
| Example 1 | | | | | | | | | | | | | |
| Comparative | — | — | — | — | G | 120 | 0.8 | PVA | — | — | — | — | 24 |
| Example 2 | | | | | | | | | | | | | |
| Comparative | — | — | — | — | E | 60 | 0.4 | PVA | — | — | — | — | 6 |
| Example 3 | | | | | | | | | | | | | |

* PVP: polyvinylpyrrolidone (trade name PVP-K30, manufactured by ISP)
PVA: polyvinyl alcohol (trade name Gosefimer Z-210, manufactured by The Nippon Synthetic Chemical Industry Co., Ltd.)

It is found from Table 1 that the support for recording material of the invention has higher light fastness (retained rate of fluorescence intensity) than the supports for recording material which are obtained in Comparative Examples.

On the other hand, it is found that the supports for recording material which are not provided with the blocking layer and obtained in Comparative Examples have significantly lower light fastness than those of Examples.

### Example 10

<<Production of Thermal Recording Material>>

[Preparation of Coating Solution (a) for Recording Layer]

—Preparation of Microcapsule Solution Including an Electron Donating Colorless Dye Precursor—

3.0 parts of crystal violet lactone was dissolved as an electron donating dye precursor in 20 parts of ethyl acetate. Then, 20 parts of alkylnaphthalene which was a high-boiling point solvent was added to the mixture, which was then evenly mixed under heating. 20 parts of a xylylenediisocyanate/trimethylolpropane adduct was further added as a capsule wall material to the solution, which was then evenly stirred to obtain a solution of electron donating colorless dye precursor.

54 parts of an aqueous 6% gelatin solution was prepared separately. The solution of electron donating colorless dye precursor was added to the gelatin solution, which was then emulsified using a homogenizer. 68 parts of water was added to the resulting emulsion and the mixture was homogenized. Thereafter, the emulsion was raised to 50° C. with stirring to run a capsule reaction for 3 hours to obtain a target electron donating dye precursor capsule solution. The average particle diameter of the capsule was 1.6 μm.

—Preparation of Electron Accepting Compound Dispersion—

30 parts of bisphenol A was added as an electron accepting compound to 150 parts of an aqueous 4% gelatin solution. The mixture was dispersed using a ball mill for 24 hours to prepare an electron accepting compound dispersion solution. The average particle diameter of the electron accepting compound in the dispersion solution was 1.2 μm.

—Preparation of Coating Solution (a)—

Then, the electron donating dye precursor capsule solution and the electron accepting compound dispersion solution were mixed with each other such that the ratio of the electron donating dye precursor/the electron accepting compound was 1/2 to prepare a target coating solution (a) for recording layer.

[Preparation of Coating Solution (b) for Recording Layer]

—Preparation of Microcapsule Solution (b) Including Diazonium Salt Compound—

2.0 parts of 4-(N-(2-(2,4-di-tert-amylphenoxy)butyryl))piperazinobenzenediazoniumhexafluoro phosphate was dissolved as a diazonium salt compound in 20 parts of ethyl acetate. Then, 20 parts of alkylnaphthalene which was a high-boiling point solvent was further added to the mixture, which was then evenly mixed under heating. 15 parts of a xylylenediisocyanate/trimethylolpropane adduct was further added as a capsule wall material to the solution, which was then evenly stirred to obtain a solution of a diazonium salt compound.

54 parts of an aqueous 6% gelatin solution was prepared separately. The solution of a diazonium salt compound was added to the gelatin solution, which was then emulsified using a homogenizer. 68 parts of water was added to the resulting emulsion and the mixture was homogenized. Thereafter, the emulsion was raised to 40° C. with stirring to run a capsule reaction for 3 hours to obtain a target diazonium salt compound capsule solution (b). The average particle diameter of the capsule was 1.1 μm.

—Preparation of Coupler Compound Emulsion (b)—

2 parts of 1-(2′-octylphenyl)-3-methyl-5-pyrazolone, 2 parts of 1,2,3-triphenylguanidine, 2 parts of 1,1-(p-hydroxyphenyl)-2-ethylhexane, 4 parts of 4,4′-(p-phenylenediisopropylidene)diphenol, 4 parts of 2-ethylhexyl-4-hydroxybenzoate, 0.3parts of tricresylphosphate, 0.1 parts of diethyl maleate and 1 part of a 70% calcium dodecylbenzenesulfonate methanol solution were dissolved as couplers in 10 parts of ethyl acetate. This solution was added to 80 parts of an aqueous 8% gelatin solution, which was then emulsified using a homogenizer for 10 minutes. Then, ethyl acetate was removed to obtain a target coupler emulsion (b).

—Preparation of Coating Solution—

Then, the diazonium salt compound capsule solution (b) and the coupler emulsion (b) were mixed with each other such that the ratio of the diazonium salt compound/the coupler was 2/3 to prepare a target coating solution (b) for recording layer.

[Coating Solution (c) for Recording Layer]

—Preparation of Microcapsule Solution (c) Including Diazonium Salt Compound—

3.0 parts of 2,5-dibutoxy-4-tolylthiobenzenediazoniumhexafluorophosphate was dissolved as a diazonium salt compound in 20 parts of ethyl acetate. Then, 20 parts of alkylnaphthalene which was a high-boiling point solvent was further added to the mixture, which was then evenly mixed under heating. 15 parts of a xylylenediisocyanate/trimethylolpropane adduct was further added as a capsule wall material to the solution, which was then evenly stirred to obtain a solution of a diazonium salt compound.

54 parts of an aqueous 6% gelatin solution was prepared separately. The solution of a diazonium salt compound was added to the gelatin solution, which was then emulsified using a homogenizer. 68 parts of water was added to the resulting emulsion and the mixture was homogenized. Thereafter, the emulsion was raised to 40° C. with stirring to run a capsule reaction for 3 hours to obtain a target diazonium salt compound capsule solution (c). The average particle diameter of the capsule was 1.0 μm.

Preparation of Coupler Compound Emulsion (c)—

2 parts of 2-chloro-5-(3-(2,4-di-tert-pentyl)phenoxypropylamino)acetoacetoanilide, 2 parts of 1,2,3-triphenylguanidine, 2 parts of 1,1-(p-hydroxyphenyl)-2-ethylhexane, 4 parts of 4,4′-(p-phenylenediisopropylidene)diphenol, 4 parts of 2-ethylhexyl-4-hydroxybenzoate, 0.3 parts of tricresylphosphate, 0.1 parts of diethyl maleate and 1 part of a 70% calcium dodecylbenzenesulfonate methanol solution were dissolved as couplers in 10 parts of ethyl acetate. This solution was added to 80 parts of an aqueous 8% gelatin solution, which was then emulsified using a homogenizer for 10 minutes. Then, ethyl acetate was removed to obtain a target coupler emulsion (c)

—Preparation of Coating Solution—

Then, the diazonium salt compound capsule solution (c) and the coupler emulsion (c) were mixed with each other such that the ratio of the diazonium salt compound/the coupler was 4/5 to prepare a target coating solution (c) for recording layer.

[Preparation of Coating Solution for Light Transmittance Control Layer]

—Preparation of Microcapsule Solution of Ultraviolet Absorber Precursor—

10 parts of [2-allyl-6-(2H-benzotriazole-2-yl)-4-t-octylphenyl]benzene sulfonate, 3 parts of 2,5-di-t-octyl-hydroquinone, 2 parts of tricresyl phosphate and 4 parts of α-methylstyrene dimer were dissolved as ultraviolet absorber precursors in 30 parts of ethyl acetate. 20 parts of xylylenediisocyanate/trimethylolpropane adduct was further added as a capsule wall agent to the solution, followed by stirring uniformly to obtain a ultraviolet absorber precursor solution.

200 parts of an aqueous 8% itaconic acid-modified polyvinyl alcohol solution was prepared separately. The ultraviolet absorber precursor solution was added to the polyvinyl alcohol solution, which was then emulsified using a homogenizer. 120 parts of water was added to the resulting emulsion and homogenized. Then, the emulsion was raised to 40° C. with stirring to run a capsule reaction for 3 hours, thereby obtaining a target ultraviolet absorber precursor capsule solution. The average particle diameter of the capsule was 0.3 μm.

—Preparation of Coating Solution—

10 parts of an aqueous 2% sodium [4-nonylphenoxytrioxyethylene]butylsulfonate solution was added to 100 parts of the ultraviolet absorber precursor capsule solution to obtain a coating solution for light transmittance control layer.

(Preparation of Coating Solution for Intermediate Layer)

2 parts of 2% sodium (4-nonylphenoxytrioxyethylene)butylsulfonate was added to 100 parts of an aqueous 10% gelatin solution to prepare a coating solution for intermediate layer.

(Preparation of Coating Solution for Protective Layer)

2.0 parts of a 20.5% zinc stearate dispersion solution (trade name: Hidrin F115, manufactured by Chukyo Yushi Co.) was added to 61 parts of an aqueous 5.0% ethylene-modified vinyl alcohol solution. 8.4 parts of an aqueous 2% sodium (4-nonylphenoxytrioxyethylene)butylsulfonate solution, 8.0 parts of a fluorine type releasing agent (trade name: ME-313, manufactured by DAIKIN INDUSTRIES, LTD.) and 0.5 parts of wheat flour starch were added to the mixture, which was then evenly stirred to prepare a PVA solution. 12.5 parts of an aqueous 20% Kaogloss (manufactured by Shiroishi-kougiyou Co., Ltd.) solution, 1.25 parts of 10% polyvinyl alcohol (trade name: PVA105, KURARAY CO., LTD.) and 0.39 parts of an aqueous 2% sodium dodecylsulfonate solution were mixed with each other separately. This mixture was dispersed using a Dyno mill to prepare a pigment solution. Then, 4.4 parts of the pigment solution was added to 80 parts of the PVA solution to prepare a coating solution for protective layer.

[Formation of Layers]

Seven layers including a recording layer (a), an intermediate layer, a recording layer (b), an intermediate layer, a recording layer (c), a light transmittance control layer and a protective layer were continuously formed by applying each coating solution simultaneously at a coating rate of 60 m/min in this order from the lower layer to the support for recording material which was obtained in Example 5. Then, each layer was dried at 30° C. under a humidity of 30% and at 40° C. under a humidity of 30% to obtain a multicolor thermal recording material of Example 10. As regards the amount of each coating solution on a solid basis, each coating solution was applied in the following amount: recording layer (a): 6.0 g/m², intermediate layer: 3.0 g/m², recording layer (b): 6.0 g/m², intermediate layer: 3.0 g/m², recording layer (c): 5.0 g/m², light transmittance control layer: 3.0 g/m² and protective layer: 1.5 g/m².

### [Examples 11 to 14]

The support for recording material which was obtained in Example 5 and used in Example 10 was changed to the supports for recording material which were obtained in Examples 6 to 9. The same procedures as in Example 10 were conducted except for the aforementioned alteration, to obtain multicolor thermal recording materials of Examples 11 to 14.

### Comparative Example 4

The support for recording material which was obtained in Example 5 and used in Example 10 was changed to the support for recording material which was obtained in Comparative Example 2. The same procedures as in Example 10 were conducted except for the aforementioned alteration, to obtain a multicolor thermal recording material of Comparative Example 4.

<<Evaluation>>

As regards each multicolor thermal recording material obtained above, its whiteness degree of background portion and light fastness of background portion were evaluated. The results are shown in Table 2.

(Whiteness Degree of Background Portion)

The recording material was irradiated with light from a ultraviolet lamp having an emission center wavelength of 420 nm and a power of 40 W for 15 seconds and then with light having an emission center wavelength of 365 nm and a power of 40 W for 15 seconds. After the recording material was irradiated, the yellow density of the background portion was measured using a color transmission and reflection densitometer (trade name: 310, manufactured by X-Rite Incorporated.). The measured yellow density of the recording material was defined as the whiteness degree of background portion.

(Light Fastness of Background Portion)

The obtained recording material was irradiated with light from a ultraviolet lamp having an emission center wavelength of 420 nm and a power of 40 W for 15 seconds and then with light having an emission center wavelength of 365 nm and a power of 40 W for 15 seconds. After the recording material was irradiated, the background portion was subjected to a color transmission and reflection densitometer (trade name: 310, manufactured by X-Rite Incorporated.) to measure the yellow density (X) of the recording material. Then, the recording material was further irradiated with light by using a xenon weather ometer (trade name: Ci5000 manufactured by Atlas Electric Devices Corp.) for 120 hours and then the yellow density (Y) of the recording material was measured in the same manner as above. The difference between the densities before and after the recording material was irradiated with light from the xenon weather ometer was defined as the light fastness of background portion.

Light fastness of background portion=

Yellow density (Y) after irradiation−Yellow density (X) before irradiation.

TABLE 2

| | | Whiteness | Light |
|---|---|---|---|
| | | degree of | fastness of |
| | Support for recording | background | background |
| | material | portion | portion |
| Example 10 | Support of Example 5 | 0.057 | 0.075 |
| Example 11 | Support of Example 6 | 0.046 | 0.073 |
| Example 12 | Support of Example 7 | 0.052 | 0.080 |
| Example 13 | Support of Example 8 | 0.031 | 0.049 |
| Example 14 | Support of Example 9 | 0.031 | 0.039 |
| Comparative | Support of Comparative | 0.035 | 0.135 |
| Example 4 | Example 2 | | |

According to the first invention, a support for recording material can be provided, which has high last fastness and can improve the whiteness degree of background portion and light fastness of background portion when used as supports of recording materials.

Also, according to the second invention, a thermal recording material having excellent fixing ability, high whiteness degree of background portion and superb light fastness of background portion can be provided.

What is claimed is:

1. A support for recording material comprising; a base support and a fluorescent whitening agent-containing layer which is disposed on the base support and contains a fluorescent whitening agent;
the support further comprising; a blocking layer on at least either one of a space between the fluorescent whitening agent-containing layer and the base support and a side of the fluorescent whitening agent-containing layer on which side the base support is not disposed.

2. The support for recording material according to claim 1, wherein the blocking layer contains a water-soluble polymer and the water-soluble polymer is either one of a polyvinyl alcohol and a gelatin.

3. The support for recording material according to claim 1, wherein the blocking layer contains a layered inorganic compound.

4. The support for recording material according to claim 3, wherein the layered inorganic compound is a water swelling synthetic mica.

5. The support for recording material according to claim 1, wherein the base support is a paper support.

6. The support for recording material according to claim 5, wherein the paper support is provided with a water resistant resin coating layer on both surfaces thereof.

7. The support for recording material according to claim 1, wherein the fluorescent whitening agent is soluble in water.

8. The support for recording material according to claim 1, the support being a support for thermal recording material.

9. The support for recording material according to claim 1, wherein the fluorescent whitening agent-containing layer has a thickness of 0.1 μm to 5 μm.

10. The support for recording material according to claim 1, wherein the blocking layer is an oxygen-blocking layer.

11. The support for recording material according to claim 1, wherein the blocking layer has a thickness of 0.1 μm to 5 μm.

12. A thermal recording material comprising;
a support comprising a base support, a fluorescent whitening agent-containing layer which is disposed on the base support and contains a fluorescent whitening agent, and a blocking layer disposed on at least either one of a space between the fluorescent whitening agent-containing layer and the base support and a side of the fluorescent whitening agent-containing layer on which side the base support is not disposed; and
at least one thermal recording layer disposed on the support.

13. The thermal recording material according to claim 12, wherein the blocking layer contains a water-soluble polymer and the water-soluble polymer is either one of a polyvinyl alcohol and a gelatin.

14. The thermal recording material according to claim 12, wherein the blocking layer contains a layered inorganic compound.

15. The thermal recording material according to claim 14, wherein the layered inorganic compound is a water swelling synthetic mica.

16. The thermal recording material according to claim 12, wherein the base support is a paper support.

17. The thermal recording material according to claim 16, wherein the paper support is provided with a water resistant resin coating layer on both surfaces thereof.

18. The thermal recording material according to claim 12, wherein the fluorescent whitening agent is soluble in water.

19. The thermal recording material according to claim 12, wherein the fluorescent whitening agent-containing layer has a thickness of 0.1 μm to 5 μm.

20. The thermal recording material according to claim 12, wherein the blocking layer has a thickness of 0.1 μm to 5 μm.
